(19) United States
(12) Patent Application Publication
(10) Pub. No.: US 2007/0167195 A1
(43) Pub. Date: Jul. 19, 2007

(54) COMMUNICATION SYSTEM, METHOD FOR EXTENDING STAND-BY TIME, AND COMPUTER READABLE MEDIUM THEREFOR

(75) Inventors: Chih-Wei Su, Taipei (TW); Xiang-Rui Chung, Taichung (TW); Kun-Hung Lee, Taipei (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: INSTITUTE FOR INFORMATION INDUSTRY, Taipei (TW)

(21) Appl. No.: 11/419,328

(22) Filed: May 19, 2006

(30) Foreign Application Priority Data
Jan. 18, 2006 (TW) 095101916

(51) Int. Cl. H04B 1/38

(52) U.S. Cl. 455/574

(57) ABSTRACT

A communication system, a method for extending stand-by time, and a computer readable medium therefor are provided. The communication system includes a mobile communication apparatus and a core network. The method and the computer readable medium therefor perform the following steps. When the mobile communication apparatus is in a low battery situation or required to enter a power saving mode by a user, it sends a signal to the core network to request to enter the power saving mode. After receiving the signal, the core network reduces a data quantity transmitted to the mobile communication apparatus, and thereby the purpose of extending stand-by time is achieved.

### CROSS-REFERENCES TO RELATED APPLICATIONS

This application claims priority to Taiwan Patent Application No. 095101916 filed on Jan. 18, 2006.

### BACKGROUND OF THE INVENTION

1. Field of the Invention

The present invention relates to a communication system, a method for extending stand-by time, and a computer readable medium therefor, specifically to a communication system, a method for extending stand-by time, and a computer readable medium therefor by reducing transmitted data quantity.

2. Descriptions of the Related Art

With the widespread use of mobile communication techniques in recent years, it is indispensable to people who use various kinds of mobile communication apparatuses in daily life. FIG. 1 is a structure diagram for depicting a prior 3G (third generation of mobile communication) UMTS (Universal Mobile Telecommunication System) application. The telecommunication system comprises a 3G UE (User Equipment) 10, a UTRAN (UMTS Terrestrial Radio Access Network) 12 and a CN (Core Network) 16, wherein the 3G UE 10 is a mobile communication apparatus, such as a cellular phone or a PDA (Personal Digital Assistant), with a wireless transmission and reception capability, and the UTRAN 12 and the CN 16 are connected through a network connection 14.

The UTRAN 12 comprises a plurality of wireless network subsystems, such as a RNS (Radio Network Subsystem) 120. The RNS 120 comprises a plurality of base stations (Node-B), like a base station 1200, and a RNC (Radio Network Controller) 1202. The base station 1200 connects with the RNC 1202 through the network connection 14. The base station 1200 provides a wireless connection for communicating with the 3G UE 10. The RNC 1202 is used for controlling wireless resources of all the base stations 1200 within its governing range as service access points to forward information to the CN 16.

The CN 16 comprises a plurality of mobile switching centers like a MSC (Mobile Switching Center) 160, a GMSC (Gateway MSC) 162, an application server 1640 and a HLR (Home Location Register) 1642, wherein the application server 1640 and the HLR 1642 are included in service servers 164 of a network agent end, and the above equipments transmit information to each other through the network connection 14. The MSC 160 is configured to provide circuit switching services. The GMSC 162 is configured to communicate with an external network 18. The application server 1640 of the service servers 164 of the network agent end is configured to execute various wireless network service applications provided by the network agent end, and the HLR 1642 is configured to record a position of the base station 1200 and the corresponding RNC 1202 registered by the 3G UE 10. Currently, the usage time of various mobile communication apparatuses (i.e. 3G UE 10 of the aforementioned) is restricted by a battery power capacitance, and a built-in power saving function is necessary for reducing power consumption and extending stand-by time. For example, the power saving function can be realized by reducing a brightness of a display screen, adjusting an operation mode of a processor to a power saving mode, etc. However, these methods for reducing power consumption only aim at the mobile communication apparatus itself without considering the service servers of the network agent end for further power reduction. This affects the effectiveness for reducing power consumption.

In conclusion, most of current communication systems provide only a low-battery alert mechanism or transfer the communication to another mobile communication apparatus while the mobile communication apparatus is in low battery. This cannot achieve a purpose of saving power consumption of the same mobile communication apparatus. The current technologies for saving power fail to combine the factors depending on both the mobile communication apparatus and the servers of the network agent end as a whole solution. Consequently, the subject invention provides a communication system, a method for extending stand-by time, and a computer readable medium therefor for solving the above problems.

### SUMMARY OF THE INVENTION

An object of this invention is to provide a communication system for extending stand-by time. The communication system comprises a mobile communication apparatus and a core network. The mobile communication apparatus transmits a signal for entering a power saving mode. The core network reduces a data quantity transmitted to the mobile communication apparatus in response to the signal to achieve the purpose of extending stand-by time.

Another object of this invention is to provide a core network used in a communication system. The communication system comprises a mobile communication apparatus. The core network reduces a data quantity transmitted to the mobile communication apparatus in response to a signal requested by the mobile communication apparatus for entering a power saving mode to achieve the purpose of extending stand-by time.

Yet a further object of this invention is to provide a communication method for extending stand-by time applied in a communication system. The communication system comprises a mobile communication apparatus and a core network. The method comprises the following steps of: transmitting a signal for entering a power saving mode by the mobile communication apparatus; and reducing a data quantity transmitted to the mobile communication apparatus by the core network in response to the signal. This method achieves the purpose of extending stand-by time.

This invention also provides a computer readable medium for storing a computer program to execute the said communication method.

By reducing communication between the mobile communication apparatus and the core network, the efficiency of power consumption is enhanced. For more obvious and easy understanding of said other purposes, features and advantages of the subject invention, the detailed descriptions are described in the following paragraphs accompanying the preferred embodiments and the appended drawings.

### BRIEF DESCRIPTION OF THE DRAWINGS

FIG. 1 is a schematic view of a prior communication system;

FIG. 2 is a schematic view of the first embodiment of the subject invention; and

FIG. 3 is a flow chart of the second embodiment of the subject invention.

### DESCRIPTION OF THE PREFERRED EMBODIMENT

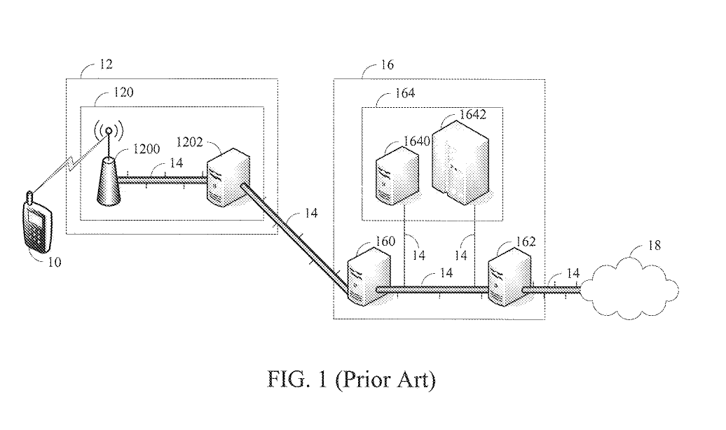

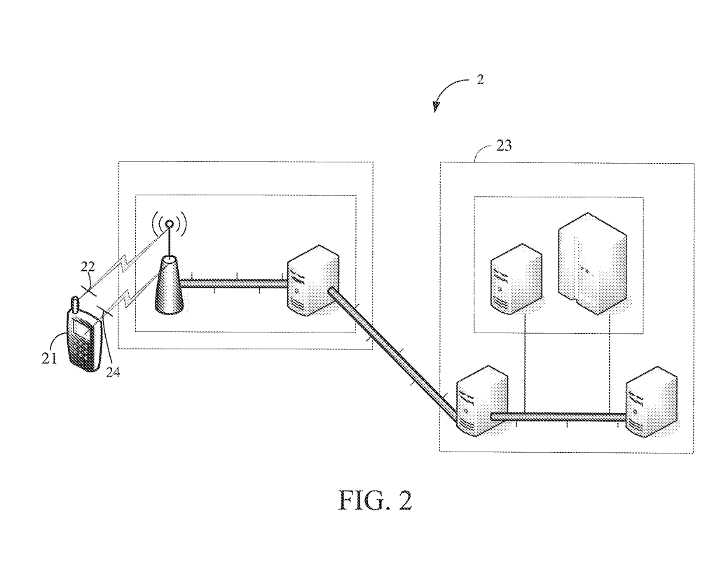

FIG. 2 is a schematic view of the first embodiment of the subject invention which is a communication system 2 comprising a mobile communication apparatus 21 and a core network 23 for extending stand-by time. The operation relationship is shown in FIG. 1 and in the section of “DESCRIPTION OF THE RELATED ART”. The mobile communication apparatus 21 transmits a signal 22 for entering a power saving mode to the core network 23. The core network 23 reduces a data quantity 24 transmitted to the mobile communication apparatus 21 in response to the signal 22 to achieve the purpose of extending stand-by time. In this embodiment, the mobile communication apparatus 21 can be a cellular phone, a PDA (Personal Digital Assistant), or a computer with wireless networking capability, etc. The core network 23 can be a service server of a network agent end or a base station, etc.

In this embodiment, while a battery power of the mobile communication apparatus 21 is lower than a threshold value such as the remaining battery power is 30%, 20%, 10%, 5% or 3% of the full battery power, the mobile communication apparatus 21 automatically transmits the signal 22 to the core network 23 to request to enter the power saving mode. The mobile communication apparatus 21 also transmits the signal 22 in response to a user's request of entering the power saving mode manually.

In the subject invention, the data quantity 24, reduced to transmit to the mobile communication apparatus 21, is set by a configuration. The core network 23 reduces the data quantity 24 according to the configuration. In detail, by setting a data processing mechanism (i.e. the configuration), different kind of information is processed in corresponding processing manners. The configuration is selected from a group consisting of a data source, a data type, a file size, data content, a data configuration, an environmental parameter, and their combination thereof. The data source is one of an incoming phone number, a sending message number, an e-mail account, an IP (Internet Protocol), a name, an account, etc. The data type is one of a real-time data, a real-time stream, a non real-time data, a non real-time stream, etc. The data content is one specific type of the data content such as a keyword or specific flag. The data configuration relates to types of the content of data transmission such as a setting of a garbage e-mail or a virus definition file, etc. The environmental parameter is a parameter related to an environment during transmission including a user location, a received signal strength of the mobile communication apparatus 21, etc. Wherein the aforementioned data source, data type, file size and data content are set by the user (i.e., user configuration), and the aforementioned data configuration and environmental parameter are set by the core network 23 (i.e., system configuration).

For various kinds of information, the communication system 2 has different data processing options including a normal option, a queue option, and a discard option. The normal option is used for processing important data. The core network 23 transmits to the mobile communication apparatus 21 directly without modifying the data. The queue option is the option that the core network 23 temporarily stores the data for transmitting later and then notifies the user of the mobile communication apparatus 21 and processes the data. The processing methods are distinguished according to the options for notifying the user and the options for data processing. The options for notifying the user comprise the manners of notifying sender, notifying receiver, notifying sender and receiver, and not notifying user. If the options for data processing are adopted, there are two manners. One is the core network 23 actively sends out the reduced data quantity 24 while the user battery power is sufficient. The other is the user accesses the reduced data quantity 24 manually but not actively sending out by the core network 23. The discard option simply deletes the messages at the core network without sending them to the mobile communication apparatus 21.

By the manner of setting the configuration, as the battery power is sufficient, the user can preset the options about what kind of data, transmitted by the core network 23, will be accepted or rejected to be received when the mobile communication apparatus 21 is in a low battery status. That is, whether the data is accepted or rejected should base on a priority order and an importance degree thereof. For example, the user can choose to receive a voice message for reducing power consumption in a low battery condition. Other voice call or multimedia short film messages are remained temporarily at the core network 23, and will be transmitted until the battery power of the mobile communication apparatus 21 is recovered.

Another example is to preset the option that only the incoming phone call, called from important people, will be answered. Once after a user's mobile communication apparatus 21 enters the power saving mode, a phone call which is called from those who are not on a list of the preset important people will be directed to a voice mailbox by the core network 23 and a voice message will be recorded. Yet another example of the invention is to preset the options to filter and to delete all messages comprising advertisements or garbage e-mails for the purpose of reducing power consumption and enhancing communication safety of the user.

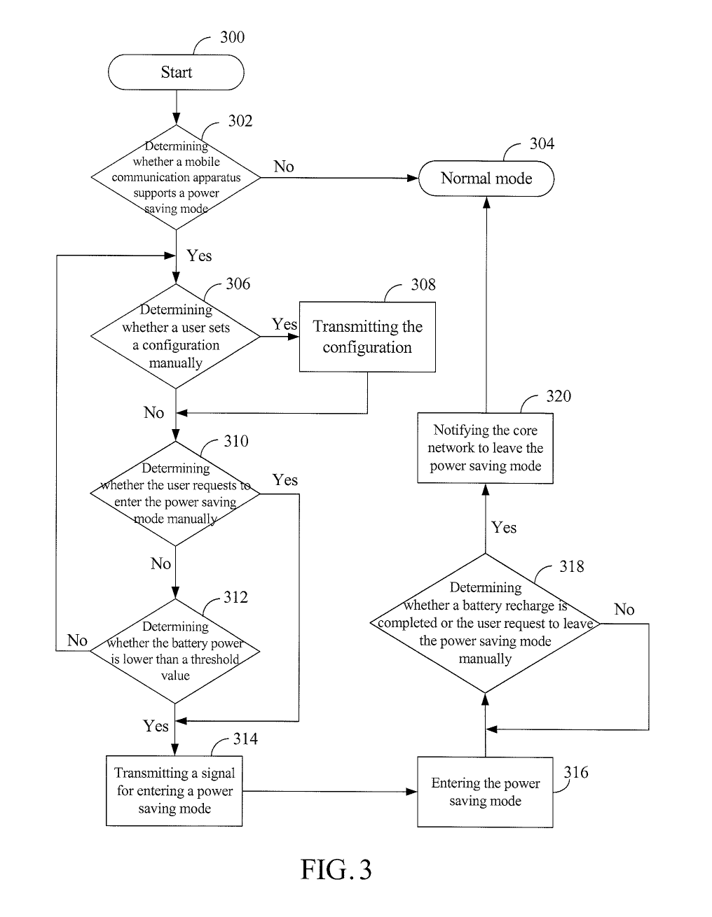

FIG. 3 is a flow chart of the second embodiment of the subject invention, illustrating a communication method of a communication system for extending stand-by time. The method starts execution in step 300. In step 302, determining whether the communication system supports a power saving mode is executed. The communication system comprises, for example, but not limited to, a core network and a mobile communication apparatus. If it is not in step 302, step 304 is executed, wherein the communication system transmits the data normally. If it is yes in step 302, step 306 is executed to determine whether a user manually sets a power saving configuration. If not, step 310 is executed. If yes, step 308 is executed to transmit the power saving configuration set by the user to the core network. After the core network receives the power saving configuration, then next step 310 is executed. In step 310, whether the user manually requests for entering the power saving mode is determined. If not, step 312 is executed. If yes, step 314 is executed. In step 312, determining whether a battery power of the mobile communication apparatus is lower than a threshold value is executed. If not, the method returns to step 306. If yes, step 314 is executed. In step 314, the mobile communication apparatus transmits a signal for entering the power saving mode to the core network to request to enter the power saving mode. In next step 316, the mobile communication apparatus enters the power saving mode. Meanwhile, the core network reduces a data quantity transmitted to the mobile communication apparatus according to the power saving configuration set by the user. In next step 318, the mobile communication apparatus determines whether a battery recharge is completed or the user request to exit the power saving mode manually. If not, step 318 is re-executed after a period of time. If yes, step 320 is executed, wherein the mobile communication apparatus sends a signal to notify the core network to exit the power saving mode. The communication system exits the power saving mode and return to step 304 for sending and receiving the data between the mobile communication apparatus and the core network normally.

The above disclosed method of the subject invention utilizes a current available battery power detection mechanism of the mobile communication apparatus and combines a current available information processing mechanism of the core network without changing the communication protocols of the prior system. The subject invention could be implemented by expanding the capacity of the application server and installing the related software programs disclosed in this subject invention, or utilizing the related hardware disclosed in this subject invention. In other words, it is unnecessary to change the existing communication protocols while realizing the subject invention since the mobile communication apparatus has the battery power detection mechanism already. The only one thing for practical application of the subject invention is to combine the aforementioned information processing mechanism of the core network with the prior art. Correspondingly, only one thing for the network agents to do is to apply the disclosed method to the service server 164 of the network agent end as shown in FIG. 1 without changing any existing equipment for application. Consequently, the subject invention can be realized under current available communication system architecture without updating any existing equipment. The subject invention is industrially applicable.

The aforementioned method can be utilized by a computer readable medium which stores a computer program for executing steps of the communication method for extending stand-by time. The computer readable medium can be one of a floppy disk, a hard disk, an optical disc, a flash disk, a tape, a network accessible database or a storage medium with the same functionality which is easily known by people who skilled in the art.

The above disclosure is related to the detailed technical contents and inventive features thereof. People skilled in this field may proceed with a variety of modifications and replacements based on the disclosures and suggestions of the invention as described without departing from the characteristics thereof Nevertheless, although such modifications and replacements are not fully disclosed in the above descriptions, they have substantially been covered in the following claims as appended.

What is claimed is:

1. A communication system for extending stand-by time, comprising:
a mobile communication apparatus for transmitting a signal for entering a power saving mode; and
a core network for reducing a data quantity transmitted to the mobile communication apparatus in response to the signal.

2. The communication system as claimed in claim 1, wherein the mobile communication apparatus transmits the signal when a battery power of the mobile communication apparatus is lower than a threshold value.

3. The communication system as claimed in claim 1, wherein the mobile communication apparatus transmits the signal in response to a user's request of entering the power saving mode manually.

4. The communication system as claimed in claim 1, wherein the core network reduces the data quantity transmitted to the mobile communication apparatus according to a configuration which is one of a data source, a data type, a file size, a data content, a data configuration, and an environmental parameter.

5. The communication system as claimed in claim 4, wherein the core network decides one of sending the data quantity automatically and being accessed by a user manually according to the data type.

6. The communication system as claimed in claim 1, wherein the mobile communication apparatus comprises a cellular phone.

7. A core network, used in a communication system, wherein the communication system comprises a mobile communication apparatus, the core network storing a computer program, which reduces a data quantity transmitted to the mobile communication apparatus in response to a signal, requested by the mobile communication apparatus, for entering a power saving mode.

8. The core network as claimed in claim 7, wherein the computer program reduces the data quantity transmitted to the mobile communication apparatus according to a configuration which is one of a data source, a data type, a file size, a data content, a data configuration, and an environmental parameter.

9. The core network as claimed in claim 8, wherein the core network decides one of sending the data quantity automatically and being accessed by a user manually according to the data type.

10. A communication method for extending stand-by time, applied in a communication system, wherein the communication system comprises a mobile communication apparatus and a core network, the method comprising:
transmitting a signal for entering a power saving mode by the mobile communication apparatus; and
reducing a data quantity transmitted to the mobile communication apparatus by the core network in response to the signal.

11. The communication method as claimed in claim 10, wherein the step of transmitting the signal for entering the power saving mode by the mobile communication apparatus is executed when the communication system supports the power saving mode.

12. The communication method as claimed in claim 10, wherein the step of reducing the data quantity transmitted to the mobile communication apparatus is according to a configuration which is one of a data source, a data type, a file size, a data content, a data configuration, and an environmental parameter.

13. The communication method as claimed in claim 12, wherein the configuration is set manually by a user through the mobile communication apparatus.

14. The communication method as claimed in claim 12, wherein the configuration is set automatically by a request set by a user through one of the core network and an external network connected with the core network.

15. The communication system as claimed in claim 12, wherein the core network decides one of sending the data quantity automatically and being accessed by a user manually according to the data type.

16. The communication method as claimed in claim 10, wherein the step of transmitting the signal by the mobile communication apparatus is executed when a user requests manually to enter the power saving mode.

17. The communication method as claimed in claim 10, wherein the step of transmitting the signal by the mobile communication apparatus is executed when a battery power of the mobile communication apparatus is lower than a threshold value.

18. The communication method as claimed in claim 10, wherein the step of notifying the core network to exit the power saving mode by the mobile communication apparatus is executed when a charge of the mobile communication apparatus is completed or a user requests manually to exit the power saving mode.

19. The communication method as claimed in claim 18, further comprising:
transmitting data, not transmitted in the power saving mode, to the mobile communication apparatus after the core network exiting the power saving mode.

20. A computer readable medium for storing a computer program to execute a communication method for extending stand-by time in a communication system, wherein the communication system comprises a mobile communication apparatus and a core network, comprising:
transmitting a signal for entering a power saving mode by the mobile communication apparatus; and
reducing a data quantity transmitted to the mobile communication apparatus by the core network in response to the signal.

21. The computer readable medium as claimed in claim 20, wherein the step of transmitting the signal for entering the power saving mode by the mobile communication apparatus is executed when the communication system supports the power saving mode.

22. The computer readable medium as claimed in claim 20, wherein the step of reducing the data quantity transmitted to the mobile communication apparatus is according to a configuration which is one of a data source, a data type, a file size, a data content, a data configuration, and an environmental parameter.

23. The computer readable medium as claimed in claim 22, wherein the configuration is set manually by a user through the mobile communication apparatus.

24. The computer readable medium as claimed in claim 22, wherein the configuration is set automatically by a request set by a user through one of the core network and an external network connected with the core network.

25. The communication system as claimed in claim 22, wherein the core network decides one of sending the data quantity automatically and being accessed by a user manually according to the data type.

26. The computer readable medium as claimed in claim 20, wherein the step of transmitting the signal by the mobile communication apparatus is executed when a user requests manually to enter the power saving mode.

27. The computer readable medium as claimed in claim 20, wherein the step of transmitting the signal by the mobile communication apparatus is executed when a battery power of the mobile communication apparatus is lower than a threshold value.

28. The computer readable medium as claimed in claim 20, wherein the step of notifying the core network to exit the power saving mode by the mobile communication apparatus is executed when a charge of the mobile communication apparatus is completed or a user requests manually to exit the power saving mode.

29. The computer readable medium as claimed in claim 28, further comprising:
transmitting data, not transmitted in the power saving mode, to the mobile communication apparatus after the core network exiting the power saving mode.
